(19) United States
(12) Patent Application Publication
(10) Pub. No.: US 2016/0009489 A1
(43) Pub. Date: Jan. 14, 2016

(54) PROPPANT STORAGE SYSTEM AND METHOD

(71) Applicant: QUICK SAND SOLUTIONS, LLC, Center, TX (US)

(72) Inventors: FRANK LOFTON, BUCKNER, AR (US); SAM HEINTZ, MAGNOLIA, AR (US); JAMES C. DONNAN, CENTER, TX (US)

(21) Appl. No.: 14/796,585

(22) Filed: Jul. 10, 2015

Related U.S. Application Data
(60) Provisional application No. 62/023,085, filed on Jul. 10, 2014.

(51) Int. Cl. B65D 88/54; B65D 90/20; B65D 88/12; B01D 46/48; F17C 13/04

(52) U.S. Cl. CPC B65D 88/54; B01D 46/48; F17C 13/04; B65D 88/12; B65D 90/20

(57) ABSTRACT

Disclosed is a proppant storage system that includes a bladder having a fill inlet configured to receive proppant into the bladder, a fill outlet configured to expel proppant from the bladder, and an air outlet configured to expel air from the bladder. A dust filter operably attached to the air outlet configured to filter air expelled from the air outlet is disclosed. Further disclosed is a valve attached to the fill outlet configured to regulate the flow of proppant expelled from the bladder. A frame is disclosed supporting the bladder. A method of processing proppant is further disclosed.

### RELATED APPLICATIONS

This application is a nonprovisional application of and claims priority to U.S. Provisional Patent Application No. 62/023,085 filed Jul. 10, 2014, entitled “MOBILE MATERIAL STORAGE UNIT AND METHOD,” which is incorporated herein by reference to the extent that it is not inconsistent with the present disclosure.

### FIELD OF TECHNOLOGY

The subject matter disclosed herein relates generally to material storage and/or processing unit. More particularly, the subject matter relates to a proppant storage system and method for storing proppants, such as sand, from job sites such as oil fracking locations.

### BACKGROUND

In the oil industry, it is often the case that material, such as sand, must be used as a proppant in fracking operations. This material is brought to a job site on trucks, tractor trailers, or other transportation means. This material is then processed and/or stored by proppant storage and/or processing systems which are also transported to the job site. These proppant storage and/or processing systems are usually mobile systems that can be transported with a tractor trailer or other truck to a fracking site.

Some proppant storage and/or processing systems, such as the Sand King®, are constructed so that they remain horizontal during operation. Existing horizontal storage and processing systems help store and convey or move proppant that has been transported to fracking sites. In particular, existing horizontal storage and processing systems use a combination of hoppers and conveyor belts to move proppant to a mixer during fracking operations. Clouds of silica dust are often seen in the vicinity of existing horizontal storage and processing systems during operation. This is because existing horizontal storage and processing systems do little to prevent dust collection. Moreover, the conveying systems provided in existing horizontal storage and processing systems often result in some proppant loss, as the sand or other proppant is often rendered unusable if it falls off a conveyor in these systems.

Alternatively, the storage and processing of materials may be accomplished through vertical storage and processing systems such as with one or more upright silos. These vertical storage and processing systems may also be transported to the job site on a tractor trailer and erected at the job site. However, a danger exists whereby these vertical storage and processing systems have fallen over due to high winds. Moreover, these vertical storage and processing systems require sand or other proppant to be provided into an open silo from above, and allowed to fall from high heights, thereby increasing the emissions of sand and dust on the jobsite.

Overall, existing proppant storage and processing systems produce excessive unsafe dust emissions during the accumulation and storage of proppant. Furthermore, existing systems do not shield the proppant from moisture, resulting in increased weight and compromised integrity of the proppant material. Furthermore, present systems often require a great deal of assembly. Therefore, it would be well received in the art to have a proppant storage system and method for easily receiving, storing and processing proppant material while minimizing dust accumulation and proppant loss.

### SUMMARY

According to a first described aspect, a proppant storage system comprises: a bladder having a fill inlet configured to receive proppant into the bladder, a fill outlet configured to expel proppant from the bladder, and an air outlet configured to expel air from the bladder; a dust filter operably attached to the air outlet configured to filter air expelled from the air outlet; and a valve attached to the fill outlet, the valve configured to regulate the flow of proppant expelled from the bladder.

According to a second described aspect, a proppant storage system comprises: a bladder having a fill inlet configured to receive proppant into the bladder, a fill outlet configured to expel proppant from the bladder, and an air outlet configured to expel air from the bladder; a dust filter operably attached to the air outlet configured to filter air expelled from the air outlet; and a frame supporting the bladder, wherein the bladder, the dust filter, and the frame are located on a trailer that is transportable by a transport tractor.

According to a third described aspect, a method of storing proppant comprises: filling a bladder with a combination of air and proppant through a fill inlet; expelling the air from the bladder through an air outlet; filtering the expelled air with a dust filter; expelling the proppant from the bladder; and regulating the flow of proppant during the expelling.

### BRIEF DESCRIPTION OF THE DRAWINGS

The subject matter disclosed herein is distinctly claimed in the claims at the conclusion of the specification. The foregoing and other features and advantages are apparent from the following detailed description taken in conjunction with the accompanying drawings in which:

FIG. 1 depicts a side view of a proppant storage system in accordance with one embodiment;

FIG. 2 depicts a top view of the material storage system in accordance with one embodiment;

FIG. 3 depicts a material storage system in accordance with another embodiment;

FIG. 4 depicts the material storage system of FIG. 3 after being lifted into a vertical position in accordance with one embodiment;

FIG. 5 depicts a schematic view of another material storage system including a plurality of the proppant storage systems of FIGS. 1-2, according to one embodiment; and

FIG. 6 depicts a schematic view of another material storage system including a plurality of the proppant storage systems of FIGS. 3-4, according to one embodiment.

### DETAILED DESCRIPTION

A detailed description of the hereinafter described embodiments of the disclosed apparatus and method are presented herein by way of exemplification and not limitation with reference to the Figures.

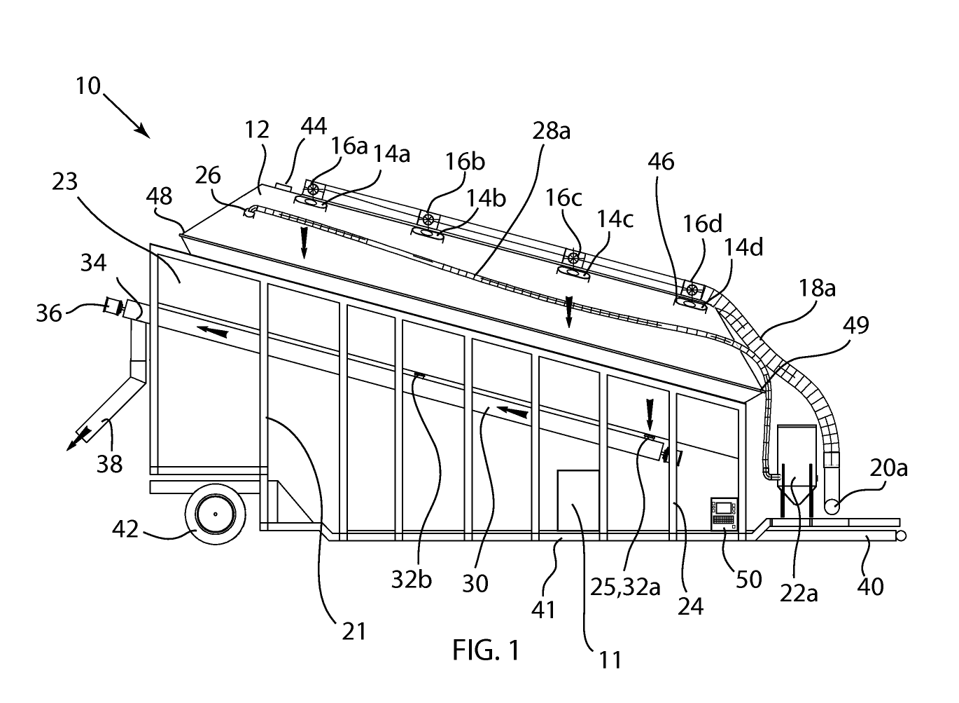

Referring first to FIG. 1, a proppant storage system 10 is shown having a bladder 12 disposed in a horizontal orientation. The bladder 12 may be inflatable and collapsible, which may allow for a greater volume system during operation that contracts for transportation to reduce the overall width when attached to a tractor on the road, as described in greater detailed hereinbelow. The bladder 12 may be made from a multi-ply rubber in one embodiment to allow for inflation and deflation. In other embodiments, other materials such as plastics, vinyl or the like may be used for the bladder 12. The bladder 12 may be made from either elastic or inelastic material(s). The bladder 12 may not be expandable and collapsible in some embodiments but may be made from a metallic structural material. A frame 24 may support the bladder 12. The frame 24 may include a number of vertical beams 21 for supporting a cradle 23. The bladder 12 is shown resting on the cradle 17, which is elevated at a first end 48 to allow proppant to fall to a lower second end 49 after it is received into the bladder 12. The angle shown, combined with the material properties of the bladder 12 may be particularly configured to allow sand or other proppant to flow, slide or otherwise move from the upper higher elevated first end 48 to the lower elevated second end 49 without the need for an auger or other movement inducing device. In one embodiment, the angle of the bladder 12 may be 15 degrees. In other embodiments, the angle may be 30 degrees or more. In other embodiments, the bladder 12 may be flatter than 15 degrees. In this embodiment, the bladder 12 may also be partially raiseable or lowerable with a hydraulic raising and lowering system (not shown).

The bladder 12 may be filled with proppant through one or more fill inlets 14a, 14b, 14c, 14d which may be located proximate a top edge running along the length of the bladder 12. The fill inlets 14a-d may be disposed evenly across the top edge of the bladder 12. The top-most fill inlet 14a may be located at a top portion of the bladder 12 proximate to the first end 48. It should be understood that more or less fill inlets 14a-d may be provided compared to number in the embodiment shown. In one embodiment, only a single fill inlet may be provided, such as the top most fill inlet 14a. The fill inlets 14a-d may be reinforced with material reinforcement 46 to prevent any rips or tears in the bladder 12 at points of structural weakness.

The fill inlets 14a-d may be configured to receive respective cam lock connectors 16a, 16b, 16c, 16d of a fill hose 18a at four different connection points in the embodiment shown in FIG. 1. The cam lock connectors 16a-d may allow the fill hose 18a to connect to the bladder 12 in a manner that may prevent dust, silica particles, sand, and/or other proppant from escaping at the connection point(s) between the fill hose 18a and the bladder 12. It should be understood that other connection mechanisms are contemplated instead of the cam lock connectors 16a-d. Other connectors that prevent dust or from escaping between the connection point(s) may include fittings, connectors, or the like. For example, the fill inlets 14a-d may be threaded and connect with corresponding threads on the fill hose 18a. Moreover, any connecting mechanisms that are air-proof or liquid tight in addition to dust proof are contemplated. The connectors 16a-d may lock, engage, connect, or otherwise create a tight joining, assembly, linkage, or construction with respective fittings located at the fill inlets 14a-d in the embodiment shown. This may be accomplished, for example, with the affecting of levers or flanges, with threads, or with a sliding interference fit. The connectors 16a-d and the fittings located at the fill inlets 14a-d may be made from polypropylene, nylon, brass, stainless steel, or any other durable or suitable material.

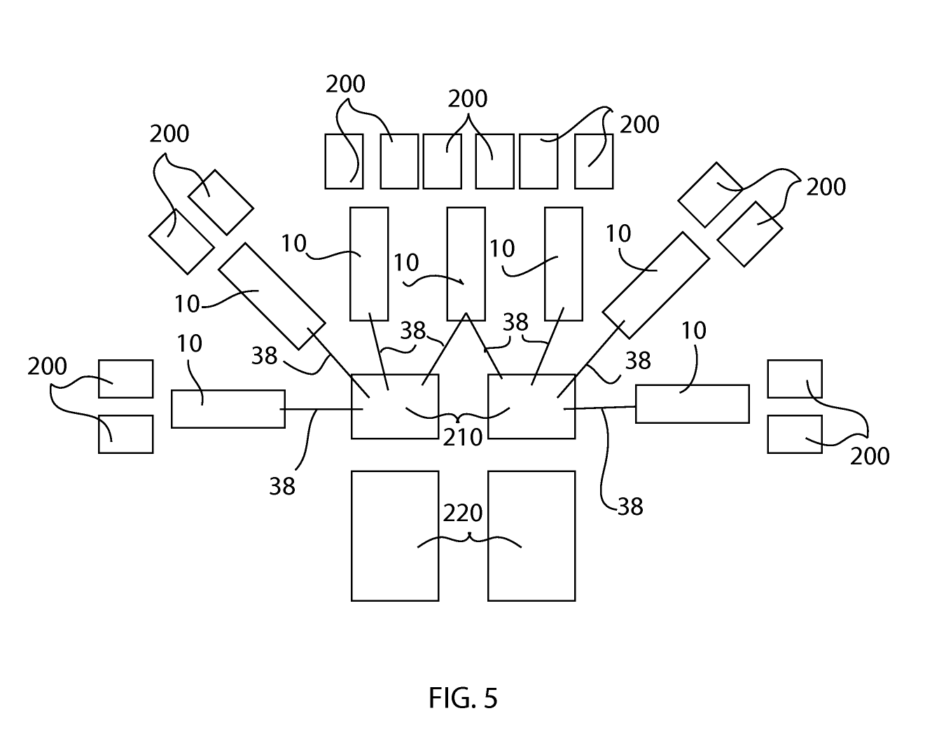

In practice, one or more proppant-carrying delivery trucks 200 (shown in FIG. 5) may arrive to a fracking location or job site for delivering sand and/or other proppant to the proppant storage system 10. The delivery truck 200 may connect to, or include, the fill hose 18a. In one embodiment, the fill hose 18a may be provided as part of the proppant storage system 10 and may then connect with a forced air/proppant system provided by the delivery truck 200. The fill hose 18a may be connected to a forced air system that moves sand or other proppant from a tank, chamber or cavity of the truck and into the fill hose 18a. The combination of the proppant and forced air may pass through the fill hose 18a and then through one or more of the cam lock connectors 16a-d and fill inlets 14a-d, thereby being provided into the bladder 12.

As the bladder 12 fills as a result of the supply of sand or other proppant coming from the fill hose 18a, the fill inlets 14a-d may become blocked as a result of the sand or other proppant within the bladder 12. As a result, the proppant and air may be pushed farther up within the fill hose 18a before entering the bladder 12 the more filled the bladder 12 becomes. The connection points between the fill inlets 14a-d and the cam lock connectors 16a-d, may further include a check valve (not shown) which prevents proppant or other fill material from escaping back into the fill hose 18 from the bladder 12. In some embodiments, the bladder 12 may begin a filling process in a collapsed or unexpanded state. In others, the bladder 12 may remain expanded before and/or during filling. In still others, the bladder 12 may not be expandable or collapsible but instead may be a fixed tank.

The bladder 12 may further include at least one fill outlet 32a, 32b. In the embodiment shown, the two fill outlets 32a, 32b are dispersed at different points along a bottom edge of the bladder 12 for expelling proppant such as sand from the bladder 12 and into an auger 30. In any embodiment, one fill outlet 32 may be located at a lowest point in the bladder 12 to always allow proppant or other material to be expelled until the bladder 12 is completely empty from proppant or other material. Like the fill inlets 14a-d, the fill outlet(s) 32a, 32b may be secured or fashioned in such a way to prevent dust, sand, silica particles, and/or proppant from escaping when it passes through the fill outlet(s) 32a, 32b. Similar fittings to any of those described hereinabove with respect to the fill inlets 14a-d are contemplated for the fill outlets 32a, 32b.

A knife valve 25 may be located at one or more of the fill outlet(s) 32a, 32b for regulating the output of proppant from the bladder 12. The knife valve 25 may be replaced by any other type of flow valve that is capable of regulating the flow of a proppant by imposing various flow rates. In other embodiments, no flow regulation or valving may be required at the fill outlets 32a, 32b. In some embodiments, the proppant storage system 10 may include a control system 50. The control system 50 may be an operator interface, a user interface, or the like. The control system 50 may include dials, buttons or the like. The control system 50 may be used to regulate the flow of proppant through the fill outlets 32a, 32b and other portions of the proppant storage system 100 as described hereinbelow. Further, the flow of proppant through the fill outlets 32a, 32b may further be reported or monitored on gauges provided by the control system 50.

An auger 30 may be located under the bladder 12 and may extend in a parallel manner along the bottom edge of the bladder 12. The auger 30 may be located under and be connected to the knife valves 25 of the fill outlets 32 such that the auger 30 receives proppant being output from the bladder 12 through the fill outlets 32. Like the knife valves 25, the auger 30 may be controlled by the control system 50. The auger 30 may be a multi-speed or variable auger. The auger 30 may expel the proppant from the bladder 12 once a storage phase is complete. The power to the auger 30 may need to be increased, for example, in the case that the sand or proppant contains increased moisture levels. The auger 30 may be located within the bladder 12 or tank in one embodiment. In this embodiment, the auger 30 may be located in the bottom of the bladder 12 or tank and may transport the sand, proppant or material to the proper height for removal from the bladder 12. In other embodiments, multiple augers may be utilized. For example, a single auger may be utilized per fill individual outlet 32a, 32b.

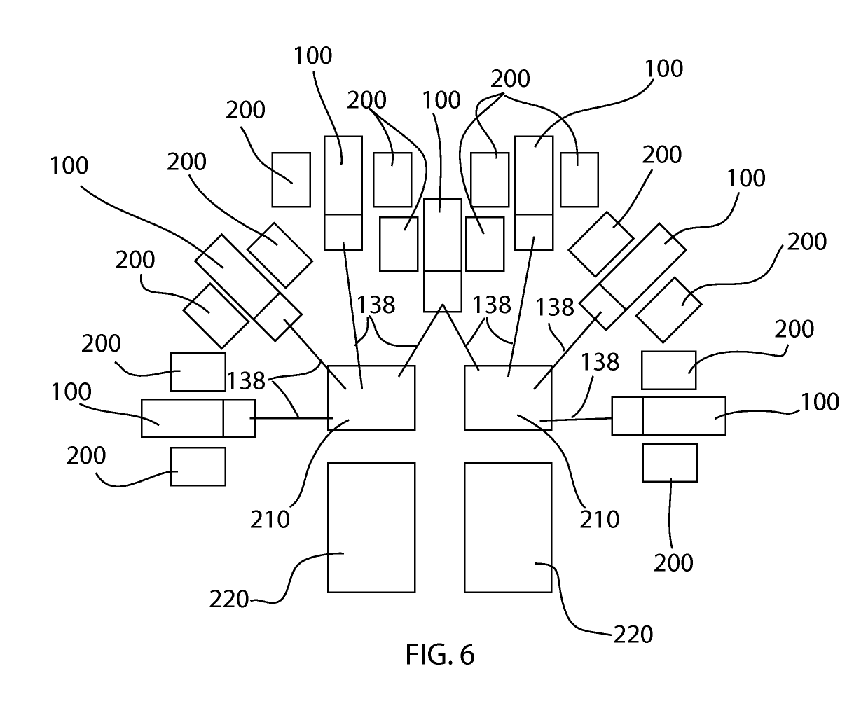

The auger 30 may provide the proppant to a particularly desired height to expel the proppant into a chute 38. This height may allow the chute 38 to then expel proppant into a proppant hopper 210 (shown in FIGS. 5 and 6) at the proper dispensing speed and volume flow rate needed on a particular fracking job. The chute 38 may be swivelable in order to provide flexibility to the arrangement of the proppant storage system 10 in the field with respect to the proppant hoppers 210, as shown in FIG. 5. Like the connections at the fill inlet 14 and the auger inlet 32, the connection between the auger 30 and the chute 38 may prevent dust, silica particles, sand, proppant or the like from being expelled. This connection at the auger outlet 34 may be air or fluid tight in some embodiments. This connection may include connectors similar to the fill inlets 14a-d or fill outlets 32a, 32b. In other embodiments, the connection at the auger outlet 34 may be screwed on or may be attached to the auger with a cam lock connection or other connection that prevents the release of dust, silica particles, sand, proppant or other material.

In some embodiments, the auger 30 may be removable from the cradle 17 and bladder 12 for cleaning and maintenance. The auger 30 may include a partially circumferential portion that may be removable from the rest of the auger 30 to allow access to the blade within the auger 30 for maintenance. Once reassembled and while in use, the auger 30 may prevent dust, silica particles, proppant, sand or the like from being expelled.

The proppant storage system 10 may also be equipped with a dust filter 22a connected to an air outlet 26a. The air outlet 26a may have a similar or the same diameter as one or more of the fill inlets 14a-d. Alternatively the air outlet 26a may have a larger or smaller diameter as the fill inlets 14a-d. The diameter of the air outlet 26a may be particularly dimensioned to prevent excess pressure build up within the bladder 12 during operation of the proppant storage system 10. During operation of the proppant storage system 10, the air outlet 26a may be use to expel air from the bladder 12 that is provided to the bladder 12 through the fill inlets 14a-d. In other words, because the sand is provided into the bladder 12 with a forced air/sand system from the delivery truck 200, eventually the bladder 12 may inflate before the bladder 12 is filled to a maximum capacity of proppant, necessitating air to be removed out of the bladder 16 to alleviate internal pressure in the bladder 12. In one embodiment, the air outlet 26a may be located at a higher position on the bladder 12 than the highest fill inlet 14a. The embodiment shows the air outlet 26a to be located proximate the first end 48. In other embodiments, the air outlet 26a may be located closer to the top edge of the bladder 12 in a similar location to the fill inlet 14a, albeit closer to the topmost apex of the bladder 12. Additional air outlets may be provided in the bladder connectable to one or more air conduits 28a, which may transport excess air to the dust filter 22a. It should be understood that, like all the other conduit connections, the air outlet 26a may prevent dust, silica particles, sand, proppant or the like from escaping.

The dust filter 22a may be configured to contain escaping dust particles and filter air expelled from the air outlet 26a. The dust filter 22a may include a filtration mechanism for filtering air prior to allowing it escape from the proppant storage system 10. This may alleviate excessive dust from being created by the proppant storage system 10. The power and rate of the dust filter 22a filtration may be regulated by the control system 50. The dust filter 22a may be located proximate a truck fill location 20a where the proppant is supplied by the delivery trucks 200. This may allow for ease of recycling sand or other proppant that may accumulate in the dust filter 22a as a result of filtration. Other locations on the trailer bed 41 or within the frame 24 for the dust filter 22a are contemplated. To recycle the sand or other proppant, a butterfly valve (not shown) may be located at the bottom of the dust filter 22a. The dust filter 22a may have a conical bottom to collect sand, dust and the like. The butterfly valve may release the proppant out of the dust filter 22a an, for example, into the vacuum mechanism of from the delivery truck's 200 forced air and proppant system (i.e. the vacuum connected to the fill hose 18a used to generate the airflow in the fill hose 18a). This may recycle the proppant collected by the dust filter 22a back into the system.

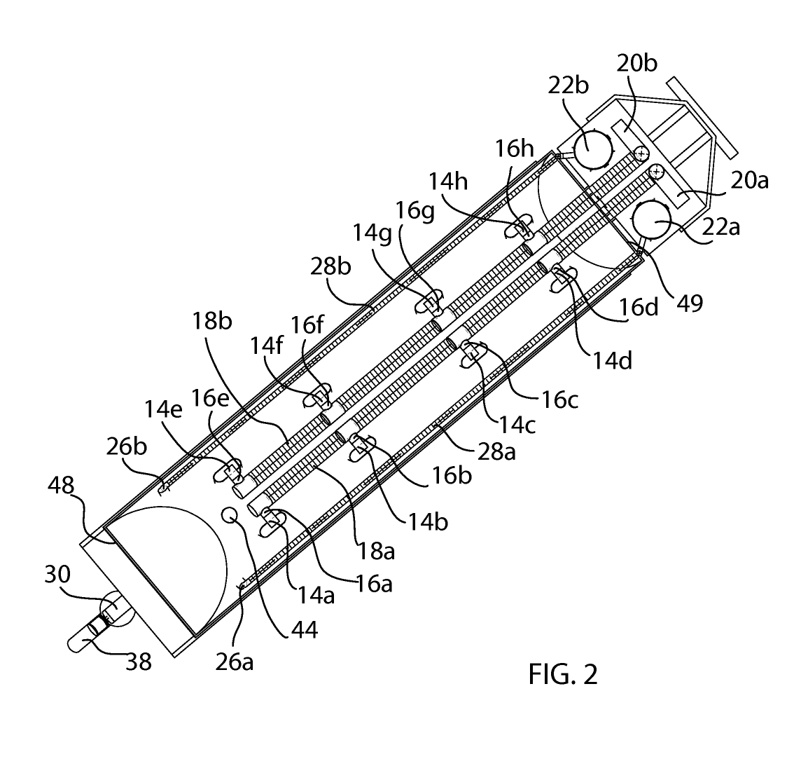

Referring now to FIG. 2, a top view of the proppant storage system 10 is shown. The proppant storage system 10 may include a second set of fill inlets 14e, 14f, 14g, 14h connected to a second fill hose 18b providing proppant from a second truck fill location 20b. Providing the capability of receiving multiple fill hoses 18a, 18b may allow the proppant storage system 10 to connect to and receive proppant from multiple delivery trucks 200, as shown in FIG. 5. Increasing the amount of proppant being introduced into the bladder 12 may allow the auger 30 to run more quickly to provide proppant to the hopper 210 at a greater rate if necessary during a fracking job. It should be understood that additional fill inlets, capable of receiving more than two fill hoses 18a, 18b are contemplated. The capability to connect to any number of fill hoses 18a, 18b limited only by the outer dimension of the bladder 12 is contemplated.

Further shown in FIG. 2 is a second air outlet 26b connected to a second dust filter 22b via a second air conduit 28b. The second dust filter 22b may be utilized as an auxiliary or back up system in case that the first dust filter 22a needs maintenance or emptying. Alternatively the second dust filter 22b may be utilized in cases where large amounts of proppant and air are being introduced into the bladder 12 through multiple fill hoses 18a, 18b.

In some embodiments, the control system 50 may include a computerized display, a microprocessor that communicates with sensors within the bladder 12 and the rest of the proppant storage system 10, memory, data storage capacity and the like. Further sensors may be provided at each of the fill inlets 14 and the fill outlets 32 to monitor proppant flow through the system. Still further, sensors may be provided at the auger outlet 34, and in the auger 30. Moreover, sensors may be provided at the air outlets 26 and at or within the dust filters 22. These sensors may each provide data to the processor of the control system 50 and analyzed by the processor. The processor may be configured to provide alerts, and other information to an operator of the proppant storage system 10. The control system 50 may further be able to control the operation of the dust filter 22, the speed of the auger 30, the operation of the knife valve(s), and may further control automatic opening and closing of the fill inlets 14 when proppant fills up to the level of each inlet. Various other aspects of the proppant storage system 10 may be controlled and monitored 50 by the control system.

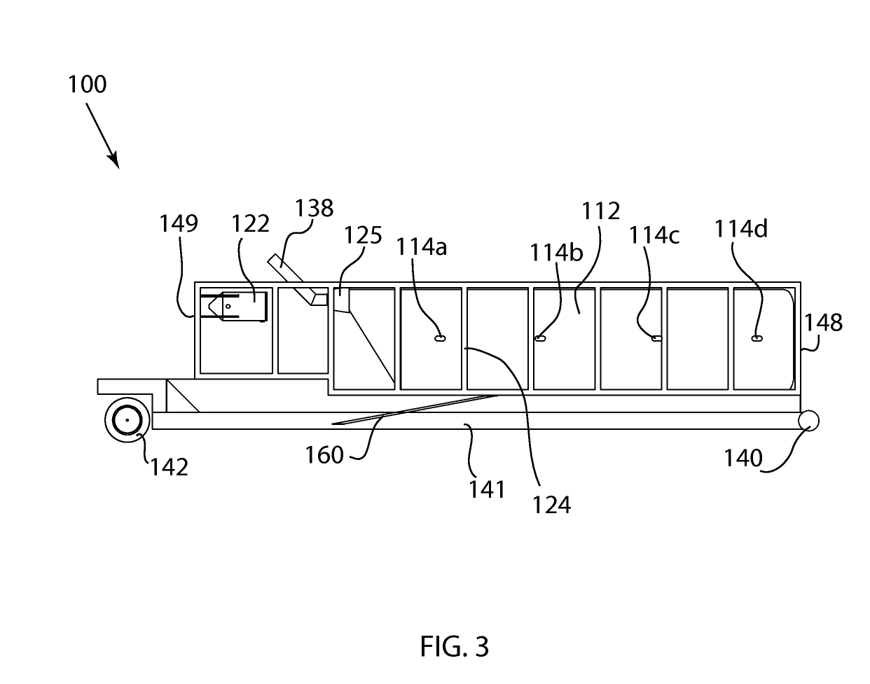

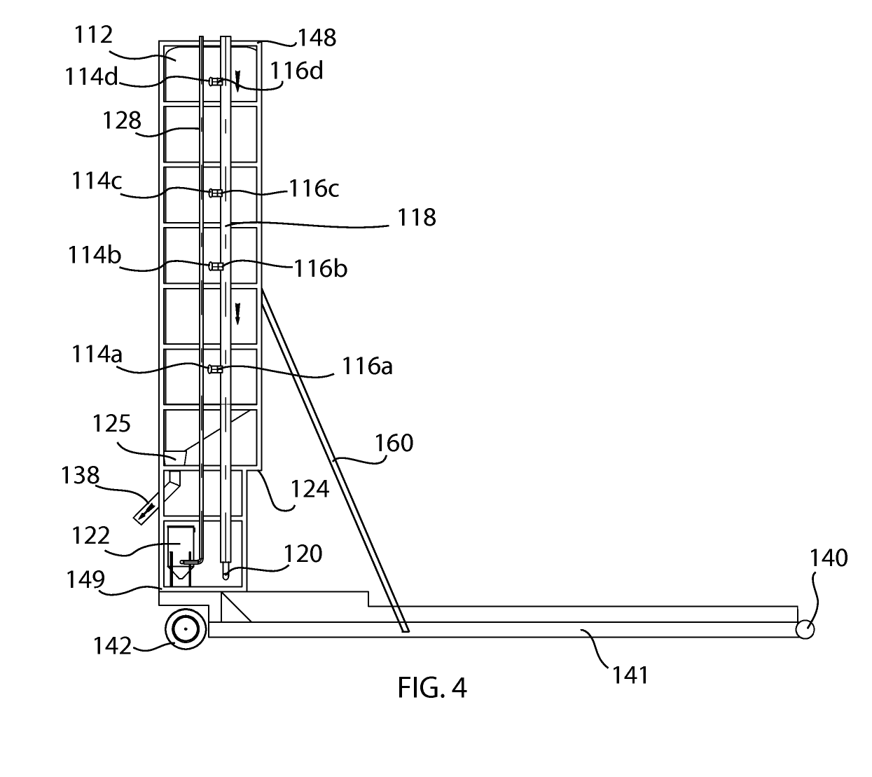

The proppant storage system 10 may further be equipped with a self-contained generator 11 to provide electricity to power the auger 30 and other ancillary components such as the control system 50, the knife valves 25. In one embodiment, the self-contained generator 11 may provide power to a hydraulic system such as the lift system 160 (described hereinbelow with respect to FIGS. 3-4), or a hydraulic compression system for compressing or deflating the bladder (also described hereinbelow). It should be understood that the proppant storage system 10 may include a hydraulic system powered by the generator 11 for powering or operating all or some of the various parts and components within the proppant storage system. The auger 30 and other ancillary components of the proppant storage system 10 may further be powered via optional external power supply connections or outlets (not shown) provided in the proppant storage system 10.

In addition to the chute 38, the proppant storage system 10 may be designed to connect to an enclosed multi-piece conveyer system (not shown). The conveyor system may be configured to transfer the material from the proppant storage system 10 to the designated point of use such as the hopper 210 (shown in FIGS. 5-6). The conveyor system may include a scale for measuring the weight, mass, and/or volume of the proppant. The conveyor system may span across a number of different proppant storage systems 10 which are set up next to each other on a job site. This conveyor system may be variably controlled and may supply accurate weighed proppant delivery and tracking of the proppant.

The bladder 12 may further be collapsible such that, when empty, the bladder 12 collapses allowing the proppant storage system 10 to be transferred over the public road systems more easily. To facilitate collapsing of the bladder 12, the bladder 12 may include a removable cap 44. Additionally, collapsing of the bladder 12 may take place when the fill hoses 18a, 18b have been removed exposing the fill inlets 14a-h. When in a fully expanded state, the bladder 12 may be wider than the typical width of a semi-tractor. However, the proppant storage system 10 may include a hydraulic system as part of the frame 24. The hydraulic system may be attached to a metallic wing elongated component that extends along the length of the bladder 12. With the cap 44 removed, once the hydraulic system is extended, the wing may compress the bladder 12 within the left and right boundaries of the frame 24, thereby preventing the bladder 12 from extending outside the bounds of a typical tractor trailer. These hydraulic cylinders may be contracted to open the wings in the system and allow the bladder 12 to expand during filling.

The proppant storage system 10 may be designed to be delivered to each site by a semi-tractor (not shown) and set in place as a single unit or with multiple units (as shown in FIG. 5). The proppant storage system 10 may include a trailer hitch 40, a trailer bed 41 and wheels 42 attached to an axle for transportation. The proppant storage system 10 is designed to use less space than existing systems. The proppant storage system 10 is designed to eliminate dust and contaminates and proppant particles from escaping into the air. In some embodiments, the proppant storage system 10 may be configured and fitted with connectors and valves for water or liquid storage applications as well as the contemplated sand storage embodiment. The proppant storage system 10 may be designed to offer a safer working environment while eliminating the need for a worker to enter the cylinder for cleaning and maintenance with improvement dust emissions creating a safer more environmental friendly operation.

The bladder 12 may be made from an inflatable multi-ply (i.e. 4-ply) rubber bag. Other materials for the bladder 12 are contemplated such as fabric, cloth, plastic or the like. The bladder 12 may have a capacity of 300,000 pounds of hydraulic fracturing proppants, such as sand. More or less capacity embodiments are envisioned. The bladder 12 may reduce the storage of moisture and environmental dust emissions and, because it is made from rubber in one embodiment, may not be configured to allow the proppant to get wet from condensation as some prior art metallic proppant storage devices allow.

Referring now to FIGS. 3-4 another embodiment of a proppant storage system 100 is shown. The proppant storage system 100 may include a bladder 112 extending between a first end 148 and a second end 149, a frame 124, and may be located on a bed 141 of a trailer with a trailer hitch 140 and a wheel 142 such that the proppant storage system 100 is transportable. The proppant storage system 100 may further include a dust filter 122, a chute 138 and fill inlets 114a, 114b, 114c, 114d.

It should be understood that the proppant storage system 100 may be similar to the proppant storage system 10 described hereinabove in many respects. The various embodiments described hereinabove with respect to the proppant storage system 10, such as the control system 50, the electrical generator 11, and the like, may also be applicable to embodiments of the proppant storage system 100. Unlike the proppant storage system 10, the proppant storage system 100 may include a lift system 160 configured to lift the bladder 112 from a horizontal position as shown in FIG. 3, into a fully vertical position, as shown in FIG. 4. The lift system 160 may include one or more hydraulic telescopic shafts for raising the frame 124 and the bladder 112 with respect to the trailer bed 141. These telescopic shafts may further slide along the length of the trailer bed 141 in some embodiments. As shown, the first end 148 of the bladder 112 may be raised and rotated about the second end 149. In the embodiment shown, the dust filter(s) 122 are attached to the frame 124 and thereby rotated during the lifting. However, it should be understood that the dust filter(s) 122 of the proppant storage system 100 may also be attached directly to the trailer bed 141 and not lifted or moved when the lift system 160 lifts the frame 124 and the bladder 112 with respect to the trailer bed 141.

The proppant storage system 100 may not include an auger, such as the auger 30. Instead, the proppant in the proppant storage system 100 may simply be expelled from the bottom of the bladder 112 once the bladder 112 has been lifted, as shown in FIG. 4. Furthermore, a knife valve 125 may be directly connected to the chute 138 in this embodiment for regulating the flow out of the bladder 112. Like the previous embodiment, it should be understood that all of the connection locations 114, 125 of the proppant storage system 100 prevent dust, silica particles, sand and/or proppant from escaping.

As shown in FIG. 4, a fill hose 118 having a plurality of cam lock connectors 116a, 116b, 116c, 116d, similar to the fill hoses 18 described hereinabove, may be connected to the bladder 112. This may be accomplished before or after the raising of the bladder 112 and frame 124 into the vertical position. The frame 124 may include a ladder for allowing an operator to climb up the frame 124 to connect fill hoses 18 to the bladder 112. The bladder 112 may include a plurality of fill inlets 114 disposed vertically along the length of the bladder 112. One additional fill inlet is not shown but may be included at the top end 148 of the bladder 112. In this embodiment, an air outlet, similar to the air outlet 26 described hereinabove, may also be located at a top end 148 of the bladder 112. Thus, an air conduit 128 may be connected at this top-most location and provide exhaust air to the dust filter 122 as shown in FIG. 4. It should be understood that more or less fill inlets 114 are contemplated than the embodiment shown. In one embodiment only one fill inlet 114 may be located at the top end 148 of the bladder 112 such that the fill always falls from the topmost point of the bladder 112 during filling.

It should be understood that the proppant storage system 100 may include a plurality of sets of fill inlets 114 for receiving a plurality of fill hoses 118 simultaneously, similar to the proppant storage 10. Further fill inlets 114 may include check valves for preventing sand or proppant from backfilling into the fill hose 118 once the sand or proppant fills within the bladder 112 to a level above the fill inlet 114.

Other mechanisms for raising the proppant storage system 100 into a vertical state are contemplated such as via an on-site crane or the like. Furthermore, the proppant storage system 100 may be attached to vertical piles driven into the ground at the base of the trailer to prevent tipping. These piles may be attached to the outer perimeter of the trailer bed 141, the trailer hitch 140 or any other trailer or frame structure found on the proppant storage system 100.

Referring now to FIG. 5, a schematic view of another material storage system including a plurality of the proppant storage systems 10 of FIGS. 1-2 is shown. In particular, shown are seven proppant storage systems 10 resting horizontally and being simultaneously filled by fourteen delivery trucks 200, two per proppant storage system. The proppant storage systems 10 are shown providing processed proppant to two separate hoppers 210. In the embodiment shown, it is contemplated that one of the proppant storage systems 10 may include two chutes 38 for providing proppant to two different hoppers 210. The hoppers 210 then supply the proppant to an operator supplied mixer unit 220.

Similarly, FIG. 6 depicts a schematic view of another material storage system including a plurality of the proppant storage systems 100 of FIGS. 3-4 sitting vertically in use. In this system, the delivery trucks 200 are shown parked closer to the base of the vertical proppant storage systems 100. It should be understood that any number of proppant storage systems 10, 100 are contemplated on a job site in any orientation for providing proppant to hoppers and/or mixer units and the like.

It should be understood that the proppant storage systems 10, 100 may be configured to store, process and/or distribute other types of materials in addition to proppants for fracking sites. For example, the storage of liquids or gases are contemplated. In these cases, in addition to prevent the escape of dust from the openings, connections and/or fixtures of the system, the storage systems may be air and/or liquid tight to prevent the escape of air or liquid. Furthermore, other embodiments are contemplated whereby the storage system is configured for the storing, processing and/or distribution of cement, asphalt, or other commonly transported building and/or construction materials.

In another embodiment, a method of processing proppant includes filling a bladder, such as the bladder 12 or the bladder 112, with a combination of air and proppant through a fill inlet, such as the fill inlet 14a-h or the fill inlet 114a-d. The method may further include expelling the air from the bladder through an air outlet, such as the air outlet 26a, 26b. The method may include filtering the expelled air with a dust filter, such as the dust filter 22, 122. The method still further may include expelling the proppant from the bladder and regulating the flow of proppant during the expelling by, for example, a valve such as the knife valve 25, 125. The method may further include collapsing the bladder. The method may further include raising the bladder to a vertical position prior to the filling of the bladder. The method may further include transporting the expelled proppant with an auger such as the auger 30. The method may still further include dispensing the expelled proppant to a fracking site such as the schematics shown in FIGS. 5-6. Still further the method may include recycling filtered proppant that accumulates in the dust filter back into the bladder. Other embodiments of the method commensurate with the description provided hereinabove are also contemplated.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A proppant storage system comprising:
a bladder having a fill inlet configured to receive proppant into the bladder, a fill outlet configured to expel proppant from the bladder, and an air outlet configured to expel air from the bladder;
a dust filter operably attached to the air outlet configured to filter air expelled from the air outlet; and
a valve attached to the fill outlet, the valve configured to regulate the flow of proppant expelled from the bladder.

2. The proppant storage system of claim 1, further comprising a frame supporting the bladder, wherein the bladder, the dust filter, the frame and the valve are located on a trailer that is transportable by a transport tractor.

3. The proppant storage system of claim 1, wherein the bladder is inflatable and collapsible.

4. The proppant storage system of claim 1, further comprising an auger configured to receive proppant from the valve and transport proppant to a higher location.

5. The proppant storage system of claim 1, further comprising a plurality of additional fill inlets dispersed across a length of the bladder.

6. The proppant storage system of claim 5, further comprising a flexible hose for providing proppant to the bladder from a transport truck, the flexible hose having a plurality of openings corresponding to the fill inlet and the plurality of additional fill inlets.

7. The proppant storage system of claim 1, further comprising a lift system configured to lift the bladder into a vertical position.

8. The proppant storage system of claim 1, wherein the dust filter is located proximate a truck fill location end of the bladder.

9. The proppant storage system of claim 1, further comprising a second air outlet and a second dust filter operably connected to the second air outlet configured to filter air expelled from the second air outlet.

10. The proppant storage system of claim 1, wherein the air outlet is located at a higher position on the bladder than the fill inlet.

11. A proppant storage system comprising:
a bladder having a fill inlet configured to receive proppant into the bladder, a fill outlet configured to expel proppant from the bladder, and an air outlet configured to expel air from the bladder;
a dust filter operably attached to the air outlet configured to filter air expelled from the air outlet; and
a frame supporting the bladder, wherein the bladder, the dust filter, and the frame are located on a trailer that is transportable by a transport tractor.

12. The proppant storage system of claim 11, further comprising a valve attached to the fill outlet, the valve configured to regulate the flow of proppant expelled from the bladder.

13. The proppant storage system of claim 11, wherein the bladder is inflatable and collapsible.

14. The proppant storage system of claim 12, further comprising an auger configured to receive proppant from the valve and transport proppant to a higher location.

15. A method of processing proppant comprises:
filling a bladder with a combination of air and proppant through a fill inlet;
expelling the air from the bladder through an air outlet;
filtering the expelled air with a dust filter;
expelling the proppant from the bladder; and
regulating the flow of proppant during the expelling.

16. The method of claim 15, further comprising collapsing the bladder.

17. The method of claim 15, further comprising raising the bladder to a vertical position prior to the filling the bladder.

18. The method of claim 15, further comprising transporting the expelled proppant with an auger.

19. The method of claim 15, further comprising dispensing the expelled proppant to a fracking site.

20. The method of claim 15, further comprising recycling filtered proppant that accumulates in the dust filter back into the bladder.
